(19) United States
(12) Patent Application Publication
(10) Pub. No.: US 2014/0060955 A1
(43) Pub. Date: Mar. 6, 2014

(54) CANISTER ARRANGEMENT STRUCTURE OF STRADDLE TYPE VEHICLE

(71) Applicant: HONDA MOTOR CO., LTD., Tokyo (JP)

(72) Inventor: Sho KONO, Wako-shi (JP)

(73) Assignee: HONDA MOTOR CO., LTD., Tokyo (JP)

(21) Appl. No.: 13/950,675

(22) Filed: Jul. 25, 2013

(30) Foreign Application Priority Data
Sep. 5, 2012 (JP) 2012-195537

(51) Int. Cl. F02M 25/08; B62K 11/00

(52) U.S. Cl. CPC F02M 25/0854; B62K 11/00
USPC 180/291; 180/68.3

(57) ABSTRACT

An engine supported on a main frame with an air cleaner disposed above a cylinder head. Air is supplied from an upper direction via an intake passage. A canister is supported above a crankcase and on the side surface of the main frame. A purge pipe connects between a front end portion of the canister and the intake passage. The purge pipe has a short length and includes a purge control valve in an intermediate portion and includes a first purge pipe for connecting the purge control valve with the canister, and a second purge pipe for connecting the purge control valve with the intake passage. Evaporated fuel from a fuel tank is supplied to the canister via a discharge pipe. A drain tube is connected at the rear end of the canister and at the lower position relative to the connecting portion of the first purge pipe.

### CROSS-REFERENCE TO RELATED APPLICATIONS

The present application claims priority under 35 USC 119 to Japanese Patent Application No. 2012-195537 filed Sep. 5, 2012 the entire contents of which are hereby incorporated by reference.

### BACKGROUND OF THE INVENTION

1. Field of the Invention

The present invention relates to a canister arrangement structure of a straddle type vehicle wherein the length of a purge pipe is shortened.

2. Description of Background Art

It is well known that in a motorcycle of a straddle type vehicle, a canister is disposed to trap evaporated fuel in a fuel tank and to supply the evaporated fuel to an engine for combustion. A horizontal cylinder of the engine extends in the front-and-rear direction and is disposed in the center of the vehicle body with an intake passage being disposed above the horizontal cylinder. The canister is disposed sideways behind the engine such that the longitudinal direction thereof corresponds to the width direction of the vehicle. A purge pipe for supplying the trapped evaporated fuel extends forward from a purge pipe connecting portion, which is provided on the end portion in the width direction of the vehicle in the canister disposed sideways, and is connected to the intake passage. See, for example, Japanese Laid-open Patent Publication No. 2009-243296.

In the above-mentioned canister arrangement structure, the engine has the horizontal cylinder extending in a forward direction with an intake passage connected to the horizontal cylinder being disposed at relatively frontward position which corresponds to the front portion of the engine. On the other hand, the canister, which is connected via the intake passage, and the purge pipe are disposed behind the engine. Moreover, a canister is disposed sideways, and a purge pipe connecting portion is provided on the end portion in the width direction of the vehicle. In such a structure, the distance between the canister, in particular, a purge pipe connecting portion and the intake passage is spaced apart, resulting in a longer length of the purge pipe. However, the purge pipe is required to be as short as possible for the purpose of effectively supplying evaporated fuel, making the pipe structure compact and reducing the weight thereof.

### SUMMARY AND OBJECTS OF THE INVENTION

It is an object of an embodiment of the present invention to reduce the length of the purge pipe to make the purge pipe as short as possible for the purpose of effectively supplying evaporated fuel to the engine.

According to an embodiment of the present invention, the canister arrangement structure of the straddle type vehicle is provided on a body frame including a main frame which extends rearwardly from a head pipe. An engine is supported to the lower portion of the main frame and includes a crankcase. A cylinder extends substantially horizontally forwardly from the front portion of the crankcase with a cylinder head attached to the front portion of the cylinder. A fuel tank is supported to the upper portion of the main frame. An intake passage connects between an air cleaner supported by the main frame and the intake port of the cylinder head. A canister stores the evaporated fuel within the fuel tank via a discharge pipe and supplies the evaporated fuel to the intake passage via a purge pipe. The canister is disposed above the engine as well as behind the intake passage. A pipe connecting portion is provided wherein the purge pipe is connected and is disposed in a front portion of the canister.

According to an embodiment of the present invention, the main frame is inclined obliquely downward to the rear direction along a vehicle body center from the head pipe. The canister is supported by the main frame while the canister is disposed longitudinally along the main frame with a drain jointing port on the rear portion thereof.

According to an embodiment of the present invention, a purge control valve of a one-way valve type controls the supply amount of the evaporated fuel, is disposed in the middle of the purge pipe and is arranged in front of the canister as well as behind the intake passage.

According to an embodiment of the present invention, the intake passage is connected to the rear portion of the air cleaner on either a left or a right side of the main frame. The canister and at least a part of the purge pipe are disposed on the other side.

According to an embodiment of the present invention, the purge control valve is disposed on the other side same as the canister.

According to an embodiment of the present invention, the canister is disposed above a protruding portion, which protrudes in the width direction of the vehicle of the engine in a plan view, such that the outer end thereof is arranged inwardly in the width direction of the vehicle relative to the protruding portion.

According to an embodiment of the present invention, the canister is disposed within the outer shape of the fuel tank in a plan view.

According to an embodiment of the present invention, the canister is disposed inside a body cover for covering the side surface of the vehicle.

According to an embodiment of the present invention, the intake passage is connected to a horizontal cylinder which is the front portion of the engine, the canister is disposed above the engine as well as behind the intake passage with a purge pipe connecting portion being provided on the front portion of the canister. Accordingly, the purge pipe connecting portion of the canister is disposed so as to be in close proximity as possible to the intake passage. Therefore, despite the fact that the intake passage is connected to the horizontal cylinder and is disposed on the front portion of the engine, it is possible to shorten the length of purge pipe, which connects between the pipe connecting portion and the intake passage, as much as possible.

According to an embodiment of the present invention, since the canister is disposed along the main frame, the canister can be supported on the main frame securely and easily. In addition, the canister is also disposed so as to be inclined along the main frame which is disposed so as to be inclined obliquely downwardly to the rear direction, which thereby can lower the drain, which is provided on the rear end portion of the canister, relative to the purge connecting portion provided on the front end portion thereof for effectively discharging the fuel within the canister.

According to an embodiment of the present invention, the purge control valve is provided in the middle of the purge pipe and is disposed in front of the canister as well as behind the intake passage, which thereby can shorten the length of the purge pipe which connects between the canister, the purge control valve and the intake passage.

According to an embodiment of the present invention, the intake passage is connected to the air cleaner on either a right or left side of the main frame, while sandwiching the main frame. The canister and the purge pipe are disposed on a side of the main frame opposite to the connection of the intake passage and the air cleaner. Accordingly, the canister and the purge pipe are disposed in close proximity to the intake passage while avoiding interference with the intake passage. Thus, the length of the purge pipe may be shortened.

According to an embodiment of the present invention, the purge control valve is also disposed on the side on which the canister and the purge pipe are disposed. The purge control valve is also disposed in close proximity to the intake passage while avoiding interference with the intake passage. Thus, the length of the purge pipe may be shorten.

According to an embodiment of the present invention, the canister is disposed above the protruding portion, which protrudes in the width direction of the vehicle of the engine in a plan view, such that the outer end thereof is arranged inwardly in the width direction of the vehicle relative to the protruding portion. Thus, the lower portion of the canister can be protected by the protruding portion.

According to an embodiment of the present invention, the canister is disposed within the outer shape of the fuel tank in a plan view. Accordingly, the length of the pipe can be shortened, and the canister can be protected by the fuel tank.

According to an embodiment of the present invention, the canister is disposed inside the body cover. Thus, the canister can be protected by the body cover, and the appearance can be improved such that the canister is not seen from outside.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a left side view of a motorcycle of a straddle type vehicle;

FIG. 2 is a drawing showing the inside of a body cover with reference to the front portion of the vehicle body of FIG. 1;

FIG. 3 is a perspective view of a body frame;

FIG. 4 is a drawing shown by enlarging the canister and the purge pipe part of FIG. 2;

FIG. 5 is a top view showing a main part of the vehicle body shown from above the fuel tank; and

FIG. 6 is a drawing showing the air cleaner with the fuel tank omitted from FIG. 5.

### DETAILED DESCRIPTION OF THE PREFERRED EMBODIMENTS

Hereinafter, an embodiment of the present invention will be described with reference to the drawings. In the drawings, directions of front and rear, upper and lower, and right and left are based on the vehicle.

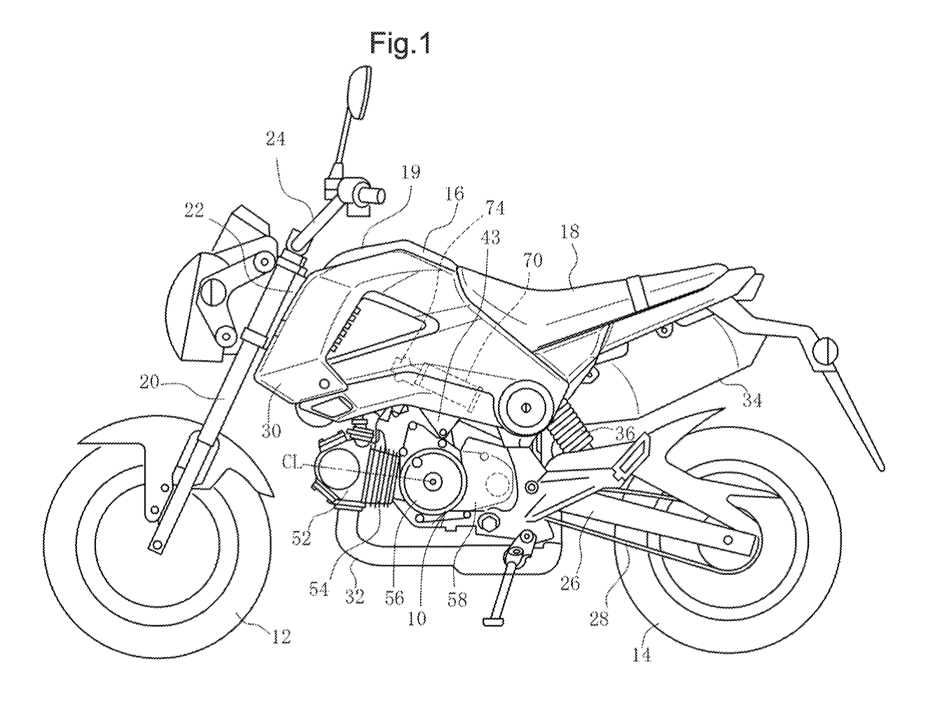

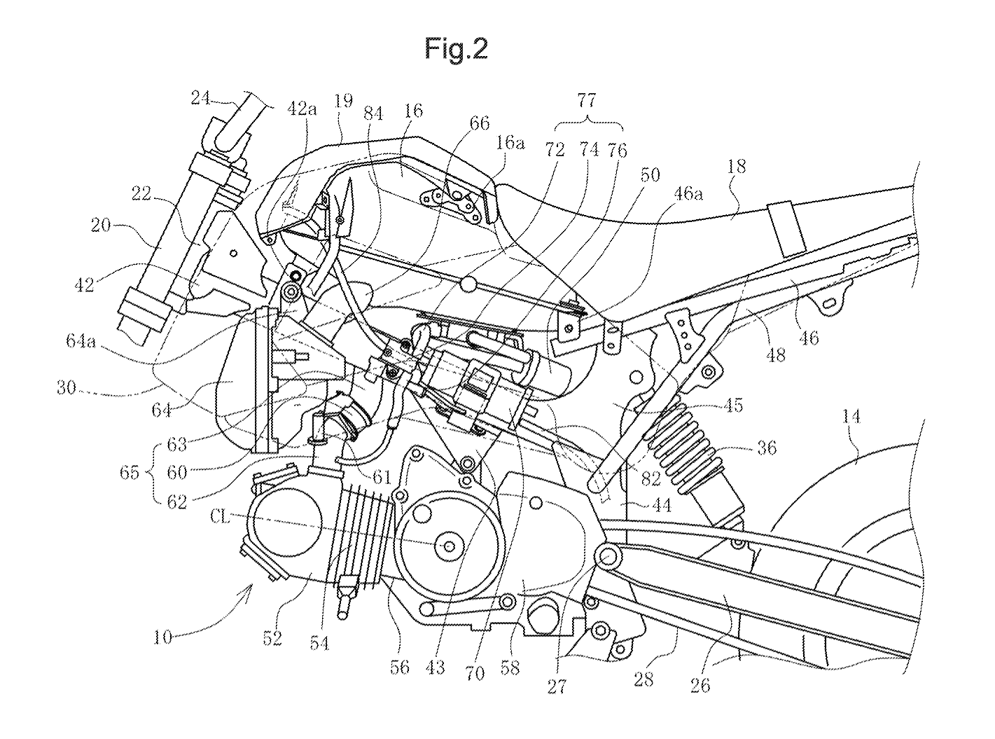

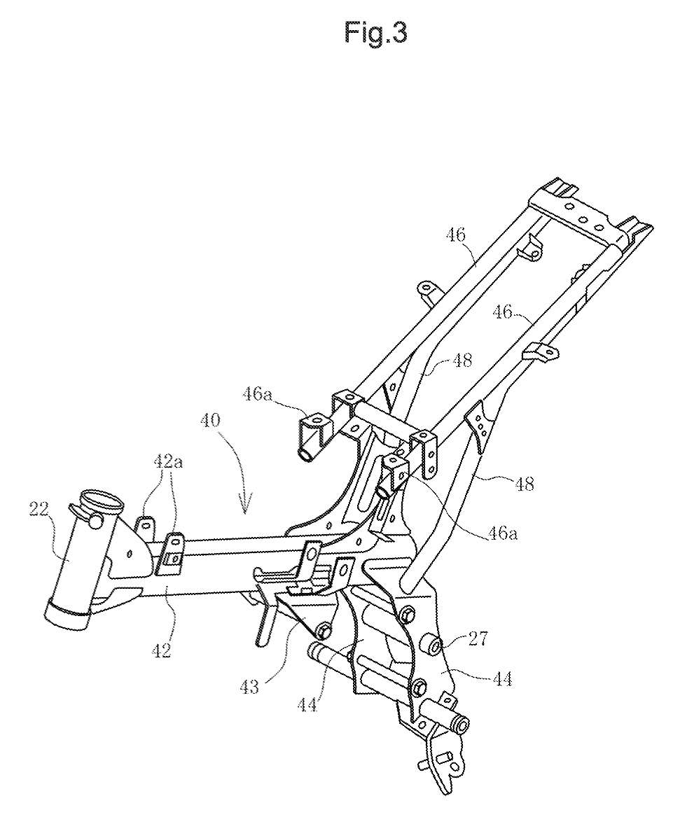

FIG. 1 is a left side view of a motorcycle of a straddle type vehicle. FIG. 2 is a drawing showing the inside of a body cover with reference to the front portion of the vehicle body of FIG. 1. FIG. 3 is a perspective view of a body frame.

In FIG. 1, an engine 10 is disposed in the center of the vehicle body with a front wheel 12 and a rear wheel 14 being disposed in the front and in the rear thereof, respectively. A fuel tank 16 is disposed above the engine 10. A seat 18 is disposed in the rear portion thereof.

The front wheel 12 is supported on the lower end of a front fork 20. The front fork 20 is rotatably supported on a head pipe 22, which is provided on the front end of a body frame (which will be described later), and is steered by a handle 24.

The rear wheel 14 is supported on the rear end of a rear swing arm 26 with the front end being of the rear swing arm 26 being swingably supported on the body frame. The rear wheel 14 is chain-driven via a chain 28 by the engine 10.

A side cover 30 (body cover) is provided for covering the side surface of the fuel tank 16 and the side surface of the vehicle body above the engine 10. An exhaust pipe 32 extends rearwardly below the engine 10, bends upwardly from the rear of the engine 10, and is connected to a muffler 34 provided below the seat 18. A rear shock absorber 36 constitutes a rear wheel suspension system.

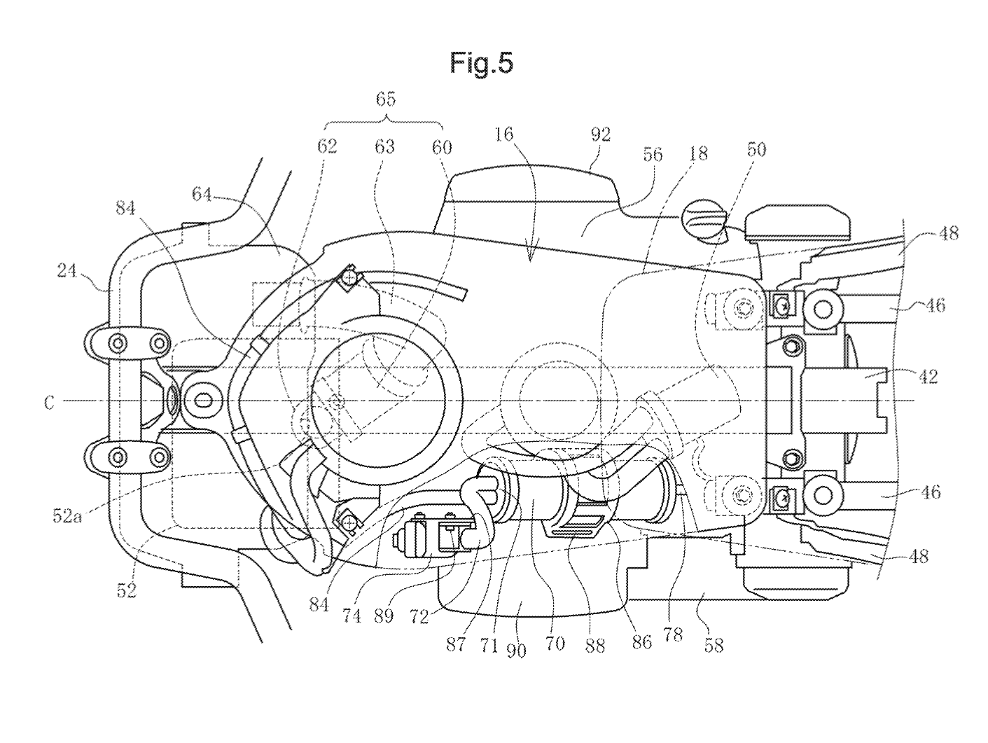

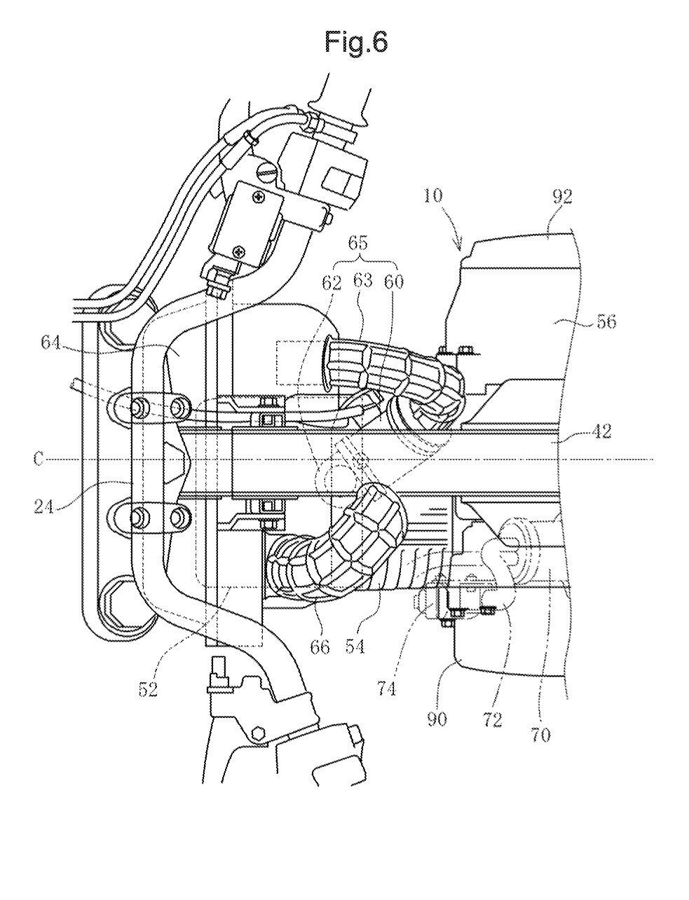

In FIG. 3, a body frame 40 comprises a main frame 42 extending obliquely downward to the rear direction along a vehicle body center C (FIGS. 5 and 6) from the head pipe 22 above the engine 10, a pair of right and left center plates 44 extending downwardly from the rear end of the main frame in the rear of the engine 10, a pair of right and left seat rails 46 extending obliquely upwardly to the rear direction from the upper end of an upwardly protruding portion 45 provided on the center plate 44, and a pair of right and left rear stays 48 for connecting the upper portion of the center plates 44 with the intermediate portion in the front-and-rear direction of the seat rails 46.

As shown in FIG. 2, the fuel tank 16 is detachably supported to a stay 42a, provided on the front portion of the main frame 42, and to a stay 46a, provided on the front end portion of the seat rail 46, above the main frame 42. A space is provided between the bottom portion of the fuel tank 16 and the upper surface of the main frame 42, in which a filter 50 of the fuel pump is disposed. The fuel pump is incorporated in the fuel tank 16.

In addition, the illustration of the side cover 30 is omitted in FIG. 2. A stay 16a is provided on the side surface of the fuel tank 16, to which the upper portion of the intermediate portion in the front-and-rear direction of the side cover 30 is detachably attached. In addition, the upper portion, which is not covered with the side cover 30, of the fuel tank 16 is covered with a tank cover 19. The tank cover 19 is also detachably attached to the stay 16a.

The front end of the rear swing arm 26 is swingably supported on the center plate 44 with a pivot shaft 27. The rear shock absorber 36 is supported between the front portion of the rear swing arm 26 and the upwardly protruding portion 45.

The engine 10 is a four-cycle air-cooled engine having a horizontal cylinder, which is substantially horizontally inclined in a forward direction such that a cylinder axis CL is inclined slightly to the front in the upper direction relative to the horizontal line. The center portion of the engine is supported to the main frame 42 via an engine hanger 43, and the rear portion thereof is supported to the center plate 44. The engine 10 comprises a cylinder head 52, a cylinder 54, a crankcase 56a and a transmission case 58 in order from the front to the rear. The cylinder 54 protrudes substantially horizontally in a forward direction from the front end portion of the crankcase 56.

A throttle body 60 is connected via a jointing pipe portion 62, which is a part thereof; on the upper surface of the cylinder head 52. The throttle body 60 is an electronic fuel injection device having a throttle valve (not shown) and a fuel injection valve 61 (FIG. 2), the fuel is sent from the fuel pump, and the purified air is supplied via the connecting tube 63 from the air cleaner 64 at the same time. The intake passage 65 in the present invention comprises the throttle body 60 and the connecting tube 63, including the jointing tube portion 62.

The air cleaner 64 is supported to the front portion of the main frame 42, which is provided above the cylinder head 52, so as to be suspended. The supporting portion is configured such that the protruding portion 64a, which protrudes upwardly from the upper portion of the air cleaner 64, is detachably fastened to the stay 42a provided on the main frame 42.

The connecting tube 63 extends downwardly from the air cleaner 64 and is connected to the throttle body 60, and sends the purified air from the upper portion of the cylinder head 52 into the throttle body 60.

In addition, an air intake duct 66 is provided that extends upwardly from the upper portion of the air cleaner 64. The upper end opening of the air intake duct is directed to the space between the bottom portion of the fuel tank 16 and the upper surface of the main frame 42.

A canister 70 is disposed on the side surface of the main frame 42 which is placed in the rear of the air cleaner as well as above the crankcase 56. The canister 70 is a device for trapping the evaporated fuel, is formed in a substantially cylindrical shape which incorporates the adsorbent for absorbing the evaporated fuel and is disposed so as to be inclined obliquely upwardly to the front direction in accordance with the inclination of the main frame 42.

The canister 70 and a purge control valve 74, which will be described later, are disposed inside the side cover 30, the outside of which is covered with the side cover 30, as shown in FIG. 1.

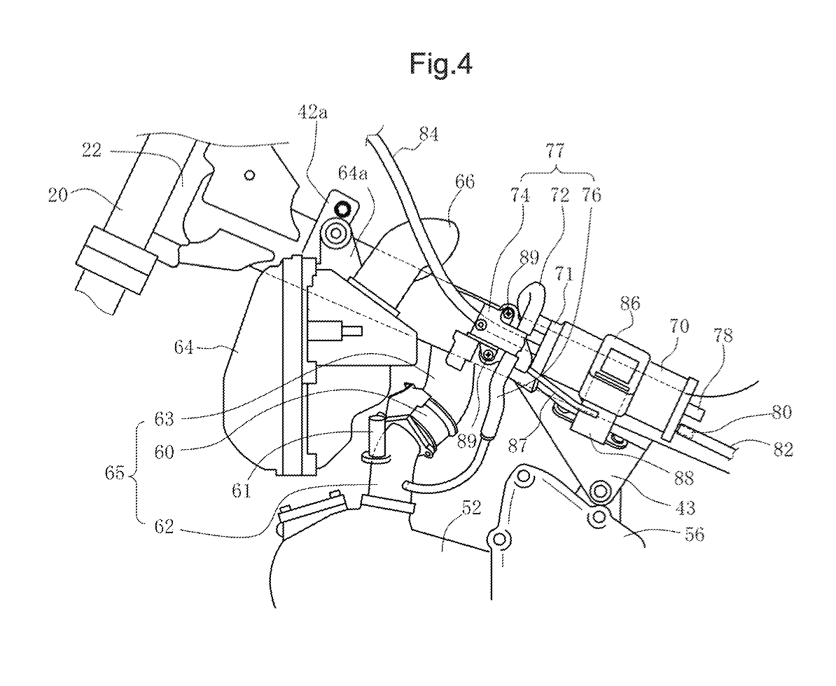

Hereinafter, the arrangement of the canister and a purge pipe will be described in detail. FIG. 4 is a drawing shown by enlarging the canister and the purge pipe part of FIG. 2. FIG. 5 is a top view showing a main part of the vehicle body shown from above the fuel tank 16. FIG. 6 is a drawing showing the air cleaner 64 with the fuel tank 16 omitted from FIG. 5.

As shown in FIG. 4, a first purge pipe 72 extends in a forward direction from the upper portion of the front end of the canister 70 and is connected to the purge control valve 74. Further, a second purge pipe 76 is connected from the purge control valve 74 to the jointing pipe portion 62. The purge control valve 74 is a one-way valve for flowing the evaporated fuel from the canister 70 to the jointing tube portion 62, is opened by the intake negative pressure of the jointing tube portion 62 to supply the evaporated fuel from the canister 70 into the jointing tube portion 62.

A purge air intake port 78 is provided on the rear end of the canister 70. The purge air intake port 78 is opened to the atmosphere, for introducing the outside air at the time of desorption of the evaporated fuel. A drain jointing port 80 is provided at the lower position relative to the purge air intake port 78 as well as at the lower position relative to the jointing position of the first purge pipe 72, to which the front end of the drain tube 82 is jointed. The drain tube 82 droops downwardly in proximity of the center plate 44, and discharges the fluid component within the canister 70 to the outside of the vehicle.

As shown in FIG. 5, the one end of a discharge pipe 84, which discharges the evaporated fuel within the fuel tank 16 to the canister 70, is jointed on the right side of the vehicle body which corresponds to the opposite side relative to the arrangement side of the canister 70, out of the upper surface of the front portion of the fuel tank 16. The canister 70 is disposed below the fuel tank 16 so as to be accommodated in the outer shape of the fuel tank 16 in a side view.

The discharge pipe 84 is installed so as to flex toward the left side at the front end portion of the fuel tank 16 while a part thereof is exposed along the upper surface of the fuel tank 16 with the other part thereof extending downwardly to be jointed to the lower portion of a front end portion 71 of the canister 70.

The front end portion 71 of the canister 70 functions as the pipe connection portion and also as the purge pipe connecting portion to which the discharge pipe 84 and the first purge pipe 72 are connected, respectively. The position to which the discharge pipe 84 is connected on the front end portion 71 is lower relative to the first purge pipe 72.

The purge control valve 74 and the canister 70 are attached to the left side surface of the main frame 42, that is, on the same side with reference to the main frame 42. The canister 70 is attached to the main frame 42 by inserting a band 86, which is wound around the circumference thereof, in a stay 88 provided on the side surface of the main frame 42. The stay 88 is attached by being fastened to the engine hanger 43. Therefore, the canister 70 is supported by being engaged via the stay 88 and the engine hanger 43 to the main frame 42.

An extending portion 87 extends from the stay 88 to the front of the canister 70, the purge control valve 74 overlaps the front end portion of the extending portion 87, and is detachably fixed by being fastened to the nut portion, which is provided on the front end portion of the extending portion 87, with a screw 89.

In addition, in a side view of the vehicle (FIG. 4), the purge control valve 74 is positioned behind relative to the air cleaner 64 as well as in proximity thereof.

Further, the purge control valve 74 and the canister 70 overlaps the upper portion of the engine 10 in a top view (FIGS. 5, 6), and at least partially overlaps a side protruding portion 90 (case for covering an AC generator in this embodiment) of the engine from above.

The protruding portion 92 is provided on the other side of the engine (case for covering a starting clutch in this embodiment).

In FIG. 6, the air cleaner 64 is disposed so as to protrude to the right and left sides while sandwiching the main frame 42. The right side is a clean side to which the connecting tube 63 is jointed, while the left side is a dirty side to which the air intake duct 66 is jointed.

The connecting tube 63 extends downwardly from the rear portion on the right side of the air cleaner 64, bends to the vehicle body center side, and is connected to the throttle body 60 at the position which slightly protrudes from the lower portion of the main frame 42 to the left side. The throttle body 60 and the jointing pipe portion 62 pass below the main frame 42 with the jointing pipe portion 62 being connected to the intake port 52a of the cylinder head 52 in proximity of the vehicle body center C.

In addition, the air intake duct 66 extends upwardly at the upper position of the rear portion on the left side of the air cleaner 64, the upper end portion of the air intake duct bends inwardly and is opened inwardly at the position above the main frame 42. That is, the intake passage 65, which comprises the throttle body 60 and the connecting tube 63 including the jointing pipe portion 62, and the intake duct 66 are disposed so as to be separated into right and left while sandwiching the main frame 42.

The purge pipe 77, which comprises the first purge pipe 72, the purge control valve 74 and the second purge pipe 76, is disposed in the rear of the air intake duct 66 in close proximity to the air intake duct without interfering with the air intake duct. However, the purge pipe 77 is disposed in a forward direction such that a part thereof partially overlaps the intake passage 65 in a side view. However, the part, which is comprised of the first purge pipe 72, the purge control valve 74 and the canister 70, and the intake passage 65 are separated into right and left, so that they are actually disposed without interfering with each other.

In addition, the air cleaner 64 overlaps the cylinder head 52 from above. In addition, the canister 70 and the purge control valve 74 are surrounded by the fuel tank 16, the main frame 42, the engine 10 and the side cover 30, which are disposed above, inside, below and outside the canister and the purge control valve, respectively.

Next, the operation will be described below. As shown in FIG. 4, the evaporated fuel within the fuel tank is absorbed into the canister 70 through the discharge pipe 84. When the negative pressure of the jointing pipe portion 62 reaches the predetermined value, the purge control valve 74 is opened to supply the evaporated fuel within the canister 70 through the purge pipe 77 into the jointing pipe portion 62, which is combusted in the cylinder head 52 together with the air-fuel mixture. At this time, the outside air is introduced into the canister 70 from the purge air intake port 78, which thereby facilitates the desorption of the evaporated fuel.

In addition, the canister 70 is disposed above the engine 10 as well as in the rear of the jointing pipe portion 62, which thereby can place the canister 70 in proximity to the jointing pipe portion 62. Thus, the canister 70 can be disposed so as not to be apart from the jointing pipe portion 62, if the jointing pipe portion 62 is positioned at the front portion of the engine 10 by being connected to the cylinder head 52 of the horizontal cylinder.

Further, since the front end portion 71 of the canister 70 functions as the purge pipe connecting portion, the purge pipe connecting portion is disposed in close proximity as possible to the jointing pipe portion 62, which thereby can shorten as much as possible the length of purge pipe 77, which comprise the first purge pipe 72, the purge control valve 74 and the second purge pipe 76.

Further, as shown in FIGS. 5 and 6, since the canister 70 and the purge control valve 74 are disposed along the left side of the main frame 42, they are disposed on the opposite side relative to the intake passage 65, which thereby can shorten the length of the purge pipe 77 as much as possible while avoiding the interference with the intake passage 65 and the jointing pipe portion 62.

In addition, by disposing the purge control valve 74 on the same side as the canister 70, it is also possible to shorten the length of the purge pipe 77 while avoiding the interference with the intake passage 65.

Moreover, the fluid component stored in the canister 70 is discharged through the drain jointing port 80 and the drain tube 82 to the outside of the vehicle. At this time, the drain jointing port 80 is provided at the lowest portion of the canister 70, which is lower than the jointing position of the first purge pipe 72. Accordingly, the fluid can be effectively discharged.

Additionally, as shown in FIG. 5, the canister 70 is disposed such that it overlaps the side protruding portion 90 of the crankcase 56 from above in a plan view (top view) and the outer end thereof is arranged inwardly relative to the side protruding portion 90. As a result, the lower portion of the canister 70 can be protected by the protruding portion 90.

Further, the canister 70 and the purge control valve 74 are disposed below the fuel tank 16 so as to be accommodated in the outer shape of the fuel tank 16 in a plan view. Accordingly, the length of the pipe can be shortened, and the canister 70 and the purge control valve 74 can be protected by the fuel tank 16.

Furthermore, the canister 70 and the purge control valve 74 are disposed inside the side cover 30. Consequently, the canister and the purge control valve can be protected by the side cover 30. Thus, the appearance can be improved such that the canister and the purge control valve are not seen from outside.

The present invention is not limited to the above-described preferred embodiment, but various modifications and applications may be made without departing from the principle of the present invention. For example, the intake passage to which the purge pipe 77 is connected, is not limited to the jointing pipe portion 62 of the throttle body 60, but may be the connecting tube 63. In addition, the vehicle applying the present invention is not limited to two-wheel motorcycles, but may be a vehicle having three or more than four wheels as long as it is a straddle type vehicle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A canister arrangement structure of a straddle vehicle having a body frame including a main frame extending rearwardly from a head pipe, comprising:
an engine supported on a lower portion of said main frame, said engine including a crankcase;
a cylinder extending substantially horizontally in a forward direction from the front portion of the crankcase and a cylinder head attached to the front portion of the cylinder;
a fuel tank supported on an upper portion of said main frame;
an intake passage for connecting between an air cleaner supported by said main frame and an intake port of said cylinder head;
a canister for storing evaporated fuel within said fuel tank via a discharge pipe and for supplying said evaporated fuel to said intake passage via a purge pipe;
said canister being disposed above said engine as well as behind said intake passage; and
a pipe connecting portion wherein said purge pipe is connected and is disposed in a front portion of said canister.

2. The canister arrangement structure of the straddle vehicle according to claim 1, wherein said main frame is inclined obliquely downwardly in a rearward direction along a vehicle body center from said head pipe; and
said canister is supported by the main frame while the canister is disposed longitudinally along said main frame, said canister including a drain jointing port on the rear portion thereof.

3. The canister arrangement structure of the straddle vehicle according to claim 1, wherein a purge control valve of a one-way valve type controls the supply amount of said evaporated fuel, said purge control valve being disposed in the middle of said purge pipe, and is arranged in front of said canister as well as behind said intake passage.

4. The canister arrangement structure of the straddle vehicle according to claim 2, wherein a purge control valve of a one-way valve type controls the supply amount of said evaporated fuel, said purge control valve being disposed in the middle of said purge pipe, and is arranged in front of said canister as well as behind said intake passage.

5. The canister arrangement structure of the straddle vehicle according to claim 1, wherein said intake passage is connected to the rear portion of said air cleaner on either a left or a right side of said main frame, and said canister and at least a part of said purge pipe are disposed on the other side.

6. The canister arrangement structure of the straddle vehicle according to claim 2, wherein said intake passage is connected to the rear portion of said air cleaner on either a left or a right side of said main frame, and said canister and at least a part of said purge pipe are disposed on the other side.

7. The canister arrangement structure of the straddle vehicle according to claim 3, wherein said intake passage is connected to the rear portion of said air cleaner on either a left or a right side of said main frame, and said canister and at least a part of said purge pipe are disposed on the other side.

8. The canister arrangement structure of the straddle vehicle according to claim 3, wherein said purge control valve is disposed on said other side same as said canister.

9. The canister arrangement structure of the straddle vehicle according to claim 4, wherein said purge control valve is disposed on said other side same as said canister.

10. The canister arrangement structure of the straddle vehicle according to claim 1, wherein said canister is disposed above a protruding portion, which protrudes in the width direction of the vehicle of said engine in a plan view, such that the outer end thereof is arranged inwardly in the width direction of the vehicle relative to said protruding portion.

11. The canister arrangement structure of the straddle vehicle according to claim 2, wherein said canister is disposed above a protruding portion, which protrudes in the width direction of the vehicle of said engine in a plan view, such that the outer end thereof is arranged inwardly in the width direction of the vehicle relative to said protruding portion.

12. The canister arrangement structure of the straddle vehicle according to claim 1, wherein said canister is disposed within the outer shape of said fuel tank in a plan view.

13. The canister arrangement structure of the straddle vehicle according to claim 2, wherein said canister is disposed within the outer shape of said fuel tank in a plan view.

14. The canister arrangement structure of the straddle vehicle according to claim 1, wherein said canister is disposed inside a body cover for covering the side surface of the vehicle.

15. The canister arrangement structure of the straddle vehicle according to claim 2, wherein said canister is disposed inside a body cover for covering the side surface of the vehicle.

16. A canister arrangement structure for use with a straddle vehicle having a body frame including a main frame extending rearwardly from a head pipe, comprising:
a fuel tank supported on an upper portion of said main frame;
an air cleaner operatively connected to the fuel tank;
an intake passage operatively connecting the air cleaner and an intake port of an engine;
a canister for storing evaporated fuel within said fuel tank via a discharge pipe and for supplying said evaporated fuel to said intake passage via a purge pipe;
said canister being disposed both above said engine and behind said intake passage; and
a pipe connecting portion wherein said purge pipe is connected and is disposed in a front portion of said canister.

17. The canister arrangement structure for use with the straddle vehicle according to claim 16, wherein said main frame is inclined obliquely downwardly in a rearward direction along a vehicle body center from said head pipe; and
said canister is supported by the main frame while the canister is disposed longitudinally along said main frame, said canister including a drain jointing port on the rear portion thereof.

18. The canister arrangement structure for use with the straddle vehicle according to claim 16, wherein a purge control valve of a one-way valve type controls the supply amount of said evaporated fuel, said purge control valve being disposed in the middle of said purge pipe, and is arranged in front of said canister as well as behind said intake passage.

19. The canister arrangement structure for use with the straddle vehicle according to claim 16, wherein said intake passage is connected to the rear portion of said air cleaner on either a left or a right side of said main frame, and said canister and at least a part of said purge pipe are disposed on the other side.

20. The canister arrangement structure for use with the straddle vehicle according to claim 18, wherein said purge control valve is disposed on said other side same as said canister.
